(19) United States
(12) Patent Application Publication
(10) Pub. No.: US 2026/0311021 A1
(43) Pub. Date: Oct. 8, 2026

(54) DIGITAL-ANALOG QUANTUM COMPUTING METHOD OF FERMION-BOSON MODELS IN SUPERCONDUCTING CIRCUITS

(71) Applicant: Kipu Quantum GmbH, Karlsruhe (DE)

(72) Inventors: Shubham Kumar, Ranchi (IN); Narendra Narayana Hegade, Bengaluru (IN); Gabriel Dario Alvarado Barrios, Guangzhou (CN); Enrique Leonidas Solano Villanueva, Berlin (DE)

(73) Assignee: Kipu Quantum GmbH, Karlsruhe (DE)

(21) Appl. No.: 19/483,338

(22) PCT Filed: May 13, 2024
(86) PCT No.: PCT/EP2024/063126

§ 371 Date: Nov. 11, 2025

(30) Foreign Application Priority Data
May 11, 2023 (EP) 23172921.1
Jun. 14, 2023 (EP) 23020289.7
Aug. 22, 2023 (EP) 23192636.1
Dec. 4, 2023 (EP) 23213981.6

(51) Int. Cl. G06N 10/40; G06N 10/20

(52) U.S. Cl. CPC G06N 10/40; G06N 10/20

(57) ABSTRACT

The invention relates to a computer-implemented method, to a computer program, and to a computer device as described herein. In particular, the invention relates to a hybrid digital-analog method for simulating fermion-boson interactions using superconducting circuits, where the target Hamiltonian H comprises tunnelling interactions, Coulomb repulsion, and at least one electron and phonon term such as the Hubbard-Holstein model, Hubbard model, Holstein model, and/or Bose-Hubbard model.

### CROSS-REFERENCE TO RELATED APPLICATIONS

This application claims priority to European patent application 23160883.7, filed May 11, 2023, European patent application 23020289.7, filed Jun. 13, 2023, and European patent application 23192636.1, filed Aug. 22, 2023, the disclosures of which is incorporated by reference herein in its entirety.

### TECHNICAL FIELD

The invention relates to quantum computing. Specifically, certain embodiments of the invention are defined by the appended claims.

The invention also relates to a method, in particular to a computer-implemented method for computing or simulating fermion-boson systems with superconducting circuits. In particular embodiments, the method is based on digital-analog quantum computation (DAQC).

### BACKGROUND OF THE INVENTION

Quantum computing is a framework for computation, which aims at outperforming classical computation by exploiting quantum mechanical phenomena. Analog quantum computing refers to a method of quantum computation that utilizes continuous variables or properties of quantum systems to perform computations. In contrast to digital quantum computing, which uses discrete quantum qubits to encode information, analog quantum computing often involves manipulating continuous quantum variables, for example the position and momentum of particles, the control field amplitudes and phase of quantum states in quantum systems. This approach aims to perform computations by directly encoding and processing information using the continuous properties of quantum systems. These systems can represent and manipulate information using the continuous properties of quantum states, potentially offering advantages in certain computational tasks compared to digital quantum computing.

In analog quantum computing, the concept of a qubit, as traditionally understood in digital quantum computing, is somewhat different due to the continuous-variable nature of analog quantum systems. In digital quantum computing, a qubit is the basic unit of information and is represented as a two-level quantum system, generally denoted by |0 [symbol] and |1 [symbol] ). It can exist in a superposition of states, allowing it to encode and process information in quantum algorithms, e.g.,

$$\frac{( \vert 0 〉 + \vert 1 〉 )}{\sqrt{2}} .$$

This plays an important role in the development of quantum algorithms outperforming classical algorithms. One example of the physical device that may be used as a qubit is an electron spin.

In analog quantum computing, qubits are not discrete entities like in digital quantum computing. Instead, continuous-variable quantum systems are utilized, and the basic unit of information is often represented by continuous quantum variables such as the position, momentum, or field amplitudes of the quantum system. These continuous variables serve as the analog counterpart to the qubit. For instance, in systems that utilize continuous-variable quantum states, properties such as the continuous amplitudes of light or the continuous degrees of freedom of quantum harmonic oscillators can be manipulated and processed to perform computations. These continuous variables play a role analogous to qubits in digital quantum computing.

Moreover, in analog quantum computing, the time evolution of qubits or continuous variables is typically described by quantum mechanical operators and equations, and it can be visualized by considering how these continuous variables change and interact with each other over time. The time evolution of quantum states under a Hamiltonian operator involves the use of quantum dynamics governed by Hamiltonians. It is described by the Schrödinger equation which is a fundamental equation in quantum mechanics. For continuous-variable systems, this equation might involve operators corresponding to position, momentum, or other continuous variables representing the system. For example, in systems involving continuous-variable quantum optics or harmonic oscillators, the evolution of field amplitudes or modes might be described by differential equations representing the dynamics of these variables under specific Hamiltonians.

In digital quantum computing, quantum gates are fundamental operations that manipulate qubits by performing specific transformations on their quantum states. These gates are crucial for performing computations and implementing quantum algorithms. However, in analog quantum computing, the operations and transformations are not discretely applied gates as in digital quantum computing. Instead of discrete quantum gates acting on individual qubits, analog quantum computing typically involves continuous operations and transformations on the continuous variables that represent the quantum states. These operations are more akin to continuous transformations, such as squeezing, displacing, or evolving the continuous properties of the quantum system over time using Hamiltonians or continuous-variable operations.

The handling and manipulation of these continuous quantum variables in analog quantum computing are different from the discrete operations performed on qubits in digital quantum computation. Analog quantum computing harnesses continuous variables, offering natural handling of continuous data and precision in computations. It holds promise for efficient quantum computation or simulation, potential error resilience, resource efficiency in certain computational tasks, high-precision measurements in sensing and metrology, and diversification of algorithms for specific computational problems. However, it is an evolving field facing challenges like error correction and scalability, with researchers working to unlock its full potential compared to digital quantum computing.

In general, while the concept of gates as discrete operations on qubits is not directly applicable in analog quantum computing, there are analogs in the form of continuous operations or transformations that affect the continuous variables characterizing a quantum system's state. These continuous transformations play a role in manipulating and evolving the quantum information encoded in the continuous-variable quantum systems, enabling computation in an analog context. Furthermore, the implementations of analog quantum computing vary between different quantum computer architectures.

### SHORT DESCRIPTION OF THE INVENTION

This summary is provided to introduce a selection of concepts in a simplified form that are further described below in the detailed description. This summary is not intended to identify key features of the invention, nor is it intended to be used to limit the scope of the invention.

The object of the invention is to provide a method for investigating the property of a material.

This object is achieved by the invention. The invention provides a digital-analog quantum computation/simulation protocol using superconducting circuits, in particular to study correlated fermion-boson interaction systems, for applications in investigating the properties of materials identified with strong fermion-boson correlation effects. Other aspect of the invention relates to quantum chemistry, machine learning, finance and optimization.

This object is also achieved, for example, by the features of the appended claims. Further embodiments and examples are apparent from the dependent claims, the description, and the accompanying drawings of the figures. In particular, the method provides an improved design of continuous quantum variables.

In a first aspect, the invention pertains to a computer-implemented method for determining a property of a material by performing a quantum computation (including a quantum simulation) of a fermion-boson system, in particular using a superconducting circuit device.

In certain embodiments, the invention relates to a hybrid digital-analog method for simulating fermion-boson interactions using superconducting circuits, where the target Hamiltonian H comprises tunnelling interactions, Coulomb repulsion, and at least one electron and phonon term such as the Hubbard-Holstein model, Hubbard model, Holstein model, and/or Bose-Hubbard model.

In certain embodiments, the method comprises:
providing a target Hamiltonian for encoding a fermion-boson interaction system representing a property of the material,
mapping the target Hamiltonian into a 1D spin-boson chain (in particular using a Jordan-Wigner transformation) wherein each spin is locally coupled to a resonator,
providing a superconducting circuit implementing a tunable (native) interaction between spins and bosons as well as tunable exchange interactions between spins and
computing (or simulating) the dynamics of the fermion-boson interaction system within the superconducting circuit, wherein the computation involves simulating the encoded interactions and measuring the its effects on the property of the material.

The target Hamiltonian is computed or simulated using native spin-boson interactions of the superconducting circuit and using tunable interactions between spins for constructing digital blocks in the form of single and/or multi-qubit gates.

Subsequently, the property of the material is derived.

Once the target Hamiltonian representing the electron-phonon interactions within the material is computed or simulated using the hybrid digital-analog quantum algorithm on the superconducting circuit, the resulting data or measurements can be analyzed to extract or deduce the specific property of the material in question. The term “therefrom” used in the claims is to indicate a conclusion or result that is directly obtained from the prior actions or processes that have just been described.

In other words, the property of the material is studied from a digital-analog quantum computation or simulation of a fermion-boson model implemented on a superconducting circuit.

The superconducting circuit (i.e. the quantum device) implements tunable interactions that allow computing or simulating the properties of a material. These interactions are activated in a particular sequence which corresponds to the digital-analog algorithm for the computation or simulation.

In certain embodiments of the method of the invention, the target Hamiltonian comprises tunnelling (exchange) interactions, Coulomb repulsion, and/or individual electron and phonon terms, in particular a Hubbard-Holstein model, a Hubbard model, a Holstein model, or a Bose-Hubbard model.

In certain embodiments of the method of the invention, the circuit elements of the superconducting circuit comprises qubits, resonators and/or SQUIDs (superconducting quantum interference device), wherein an magnetic flux is supplied to the SQUIDs to control the interactions in the circuit.

In certain embodiments of the method of the invention, the linear chain mapping, in particular a 1D linear chain mapping, of electron-phonon interactions is performed, in particular using a Jordan-Wigner transformation.

The target Hamiltonian is to be computed or simulated. The target Hamiltonian is achieved by first computing the system (device) Hamiltonian, then selecting its parameters. The system (device) Hamiltonian is computed by applying a transformation, in particular the Jordan-Wigner transformation on the device interactions take it into a form that can be addressed by the algorithm. The algorithm requires that certain interactions are activated in a particular sequence in order to compute or simulate all the terms of the target Hamiltonian. Then, the superconducting circuit is controlled to reproduce the sequence of interactions required by the algorithm.

In certain embodiments of the invention, the method includes providing a superconducting circuit comprising transmon qubits coupled to each other via resonators and SQUIDs and computing the Hamiltonian of this design. For this computed Hamiltonian of the device, parameters can be changed by tuning the device using external flux applied on the SQUIDs to achieve the target Hamiltonian to simulate the desired physical system of interest such as fermion-bosons, fermion-fermion or boson-boson interactions.

The Hamiltonian in its original form can be written in terms of fermionic and bosonic operators. In certain embodiments, these are mapped into spin operators (i.e. the qubits in the superconducting circuit) by means of a Jordan-Wigner transformation. The bosonic operators can be directly represented by a resonator (physically, it is a LC-circuit described by a quantum harmonic oscillator) and do not need a particular transformation.

In certain embodiments of the method of the invention, a system or device Hamiltonian of the superconducting circuit is provided that is decomposed into interactions that are used for the digital blocks and for the analog blocks. The target Hamiltonian is achieved after choosing the parameters of the system Hamiltonian.

In certain embodiments of the method of the invention, the interaction between the qubits and the resonators is used for the analog blocks, and is adapted to be equal to the spin-boson interaction in the target Hamiltonian up to single qubit rotations.

In certain embodiments of the method of the invention, the interactions between the qubits are used for the digital blocks in the form of single and/or multi-qubit gates.

In certain embodiments of the method of the invention, the Hamiltonian that describes the superconducting circuit considers several tunable interactions that need to be activated and deactivated in a particular sequence in order to approximate the target Hamiltonian using a trotterization method.

In particular, the interactions that are transformed are chosen from the group consisting of exchange interaction and Coulomb interaction between fermions.

In certain embodiments of the method of the invention, the interactions are exchange and/or Coulomb interactions comprising the digital blocks and bosonic and fermi-bosonic interactions comprising the analog blocks.

Some interactions present in the superconducting circuit are already almost identical to some of the interactions in the target Hamiltonian, these interactions compose the analog blocks. On the other hand, some interactions in the superconducting circuit need to be applied (or combined) in a particular sequence to replicate the remaining interactions in the target Hamiltonian.

A target Hamiltonian is to be computed or simulated. However, in its original form it cannot be directly computed or simulated, so mathematical transformations may be performed in certain embodiments, in particular a Jordan-Wigner transformation, to take it into a form that can be addressed by the algorithm. The algorithm requires that certain interactions are activated in a particular sequence in order to computed or simulate all the terms of the target Hamiltonian. Then, the superconducting circuit is controlled in order to reproduce the sequence of interactions required by the algorithm.

In certain embodiments of the method of the invention, the superconducting circuit is a 1D superconducting circuit.

In a second aspect, the invention pertains to a computer program having a program code for performing the method of the invention as described herein, when the computer program is executed on a computer, a processor, a quantum-processing unit and/or a programmable hardware component.

In a third aspect, the invention pertains to a computation device comprising: an interface for communicating with a quantum-processing unit; and one or more processors configured to perform the method of the invention as described herein using the quantum-processing unit.

In a fourth aspect, the invention pertains to the use of a superconducting state for quantum computation with superconducting circuits.

In a fifth aspect, the invention pertains to a superconducting circuit device for investigating a property of a material, in particular by performing a quantum computation or simulation of a fermion-boson system. In certain embodiments, the superconducting circuit device comprises: qubits, resonators and/or SQUIDs, wherein a magnetic flux is supplied to the SQUIDs to control the interactions in the circuit.

### DETAILED DESCRIPTION OF THE INVENTION

Various embodiments of the invention are further described in more detail with reference to the accompanying drawings. However, the invention may be embodied in many other forms and should not be construed as limited to any certain structure or function discussed in the following description.

According to the description, it will be apparent to the ones skilled in the art that the scope of the invention encompasses any embodiment thereof, which is disclosed herein, irrespective of whether this embodiment is implemented independently or in concert with any other embodiment of the invention. For example, the method disclosed herein may be implemented in practice by using any numbers of the embodiments provided herein. Furthermore, it will be understood that any embodiment of the invention may be implemented using one or more of the elements presented in the appended claims.

The invention relates to a computer program, to a computer device, and to a method, in particular to a computer-implemented method, as described herein.

In one aspect, the invention refers to a method for simulating fermion-boson interaction problems as described herein. In certain embodiments, the invention can also be applied in chemistry for quantum simulations. Such simulation problems may refer to complex electronic structures in atoms and molecules.

The method is applicable to study systems with strong electron-phonon interactions that may be studied with the present invention in particular embodiments are phenomena prevalent in various materials, condensed matter systems, and biomolecules where the idea is to efficiently simulate such systems using a digital-analog quantum device that requires fewer resource costs in comparison to purely digital or analog quantum device.

An electron-phonon interaction is considered “strong” if the strength of the interaction is comparable to the transfer amplitude between nearest-neighbor fermionic sites or to the phonon frequency.

The term fermion is defined as a particle obeying Fermi-Dirac statistics for half-integer spin, and therefore are subject to Pauli's exclusion principle. The term boson is defined as a particle obeying Fermi-Dirac statistics for integer spin.

In certain embodiments, the invention relates to a hybrid digital-analog method for simulating fermion-boson interactions using superconducting circuits, where the target Hamiltonian H comprises tunnelling (exchange) interactions, Coulomb repulsion, and at least one electron and phonon term such as selected from the group consisting of the Hubbard-Holstein model, Hubbard model, Holstein model, and Bose-Hubbard model.

In one aspect, the invention relates to a computer-implemented hybrid digital-analog method for determining a property of a material, comprising
providing a target Hamiltonian encoding an fermion-boson interaction system (or fermion-boson system) representing the property of the material,
mapping the target Hamiltonian into a 1D spin-boson chain, in particular using a Jordan-Wigner transformation, wherein each spin of the 1D spin-boson chain is locally coupled to a resonator of a superconducting circuit that is provided for implementing a tunable interaction between spins and bosons and tunable exchange interactions between spins, and
computing the dynamics of the fermion-boson interaction system within the superconducting circuit, wherein the computation involves simulating the encoded interactions and measuring the its effects on the property of the material, and
deriving therefrom the property of the material. Once the target Hamiltonian representing the electron-phonon interactions within the material is simulated using the hybrid digital-analog quantum algorithm on the superconducting circuit, the resulting data or measurements can be analyzed to extract or deduce the specific property of the material.

In certain embodiments, mapping the target Hamiltonian into a 1D spin chain is performed using a Jordan-Wigner transformation.

In certain embodiments, a Jordan-Wigner transformation is used to map the fermionic part in a purely fermionic, or hybrid fermionic-bosonic system described by the Hamiltonian into a spin or hybrid spin-bosonic system.

In embodiments in which the system is purely bosonic, there is no feed for a Jordan-Wigner transformation.

Each spin in the 1D chain represents an fermion, and each is coupled to a quantum resonator representing bosonic degrees of freedom.

The target Hamiltonian encoding the fermion-boson interaction system representing the property of the material may have the following form, H=Hₑₗ+Hₑₗ₋ₑₗ+Hₚₕ+Hᵢₙₜ. Here,

$${H}_{el} = - t \sum {\text{?}}_{i , σ} ( {c}_{i , σ}^{†} {c}_{i + 1 , σ} + {c}_{i + 1 , σ}^{†} {c}_{i , σ} )$$

is the tunneling term, Hₑₗ₋ₑₗ represents the Coulomb repulsion energy, and is given by Hₑₗ₋ₑₗ=UΣᵢn_{i↑}n_{i↓}, U is the Coulomb repulsion, ω₀ is the frequency of the phonon modes. The interaction term Hᵢₙₜ captures the coupling between the electrons and phonons, formulated as

$${H}_{int} = g {\sum }_{i , σ} {n}_{iσ} ( {a}_{i} + {a}_{i}^{†} ) ,$$

where g indicates the interaction strength between electrons and phonons and σ=↑↓. The phononic part, Hₚₕ, describes the lattice vibrations or phonons as a set of harmonic oscillators:

$${H}_{ph} = {ℏω}_{0} {\sum }_{i} {a}_{i}^{†} {a}_{i} ,$$

with ω₀ being the frequency of phonon mode at, a are the corresponding phonon operators.

This Hamiltonian framework is fundamental in studying the electron-phonon interactions that influence the electrical and thermal properties of materials.

A Hamiltonian of the superconducting circuit is provided in certain embodiments that is decomposed into interactions that are used for the digital blocks and for the analog blocks. This may be done by using the natural interactions as of the system as the analog blocks such as the interactions described by the Hamiltonian of the system (device) as the analog block. This means H=Hₑₗ+Hₑₗ₋ₑₗ+Hₚₕ+Hᵢₙₜ is the analog block and the external flux applied on device via the resonators constitute the digital blocks. After selecting some the parameters by of the system (device) Hamiltonian by tuning the device with the external magnetic flux, one can reach the target Hamiltonian.

A superconducting circuit is an electrical circuit that uses superconductors as its conducting material. Superconductors are materials that can conduct electricity with zero electrical resistance when cooled below a certain critical temperature. This unique property allows superconducting circuits to carry large currents without energy loss, making them extremely efficient.

In certain embodiments, the step of mapping the target Hamiltonian into a 1D spin chain using a Jordan-Wigner transformation, wherein each spin is locally coupled to a resonator comprises the steps 1) to 6) of:

1) Identifying and defining the target Hamiltonian of the quantum system to be simulated. This Hamiltonian usually describes the interactions and dynamics of fermions and bosons, such as electrons and phonons in a material.

2) Employing the Jordan-Wigner transformation to convert the fermionic operators in the target Hamiltonian into spin operators. This transformation maps each fermionic and bosonic creation and annihilation operator to a string of Pauli matrices, thereby reformulating the target Hamiltonian in terms of spin variables. This step is essential as it transforms the problem or target Hamiltonian from the fermionic domain, which involves anticommutation relations, into the spin domain, which is easier to handle in quantum simulations or computations.

3) Once the transformation is applied, organizing these spins in a one-dimensional chain. Each spin in this chain corresponds to a fermionic mode in the original Hamiltonian. The locality of fermionic interactions in the target Hamiltonian translates into local and non-local interactions between spins along the chain.

4) To realize this spin chain into a superconducting circuit, each spin is then locally coupled to an individual superconducting resonator using SQUIDs. These resonators are crucial as they allow for the realization of bosonic modes. The SQUIDs allow for controlling the superconducting circuit or the device and tuning its parameters to reach the target Hamiltonian.

5) From the step 4), the superconducting circuit or the device Hamiltonian is calculated. Then the parameters of this device Hamiltonian is changed using external flux applied to the SQUID so the device Hamiltonian can match the target Hamiltonian to be simulated,

6) The entire system is calibrated and controlled via external magnetic and electric fluxes, allowing for precise manipulation of the spins and their interactions as dictated by the transformed Hamiltonian. This setup is used to simulate the dynamics of the original quantum system.

The mapping performed may be a linear chain mapping of the fermion-boson (electron-phonon) interactions, in particular using the Jordan-Wigner transformation. This may be done by using the mapping of the fermionic operator

$${c}_{i} \to {\prod }_{j = 1}^{} {}^{i - 1} {σ}_{j}^{z} {σ}_{i}^{-} ,$$

Here, a fermionic annihilation operator ci is represented as a product of Pauli-Z operators

$$( {σ}_{j}^{z} )$$

up to the i−1 position, followed by a Pauli-X operator (σᵢ⁻) at the i position. This representation translates the anticommutation relations of fermions into the commuting spin operators used in quantum circuits, making it possible to simulate fermionic systems, like electrons in a lattice, using superconducting circuits.

The provided superconducting circuit comprises or consists of coupled transmon qubits to realize the spins and resonators to realize the bosonic modes. And this coupling is mediated using SQUIDs.

The array of transmon qubits and resonators realized via coupling them using SQUIDs implements a tunable interaction between spins and bosons and tunable exchange interactions between spins is realized in the same setup by the tunable interaction between the transmon qubits.

Implementing a tunable interaction between spins and bosons as well as tunable exchange interactions between spins refers to the ability to dynamically adjust and control the strength and nature of the interactions in a quantum system.

Implementing a tunable interaction means applying external magnetic flux to the SQUIDs to change the interaction strength between qubit-qubit resonator-qubit or resonator-resonator to achieve a desired interaction or coupling strength.

The fermion-boson system is generated or realized by implementing the tunable interaction in the device to reach the target Hamiltonian describing the fermion-boson system.

The target Hamiltonian is computed using the superconducting circuit by using the native spin-boson interaction of the superconducting circuit and using the tunable interactions between spins for constructing digital blocks in the form of single and/or multi-qubit gates. Specifically, this can be done by applying external magnetic flux to the SQUID that implements the digital blocks and implements tunable interactions to reach the target Hamiltonian.

Deriving the property of the material is done by studying the dynamics of the Hamiltonian, which involves evolving it over time after implementing tunable interactions. This process can also be achieved by selecting appropriate parameters following the implementation of tunable interactions, in order to reach the ground state of the target Hamiltonian.

In certain embodiments, the term_quantum computation may include a quantum simulation. In other embodiments, the term quantum computation excludes a quantum simulation.

The target Hamiltonian H is in certain embodiments simulated using a superconducting architecture by making use of the natural interactions provided by the device as analog blocks and applying digital pulses to engineer the digital blocks in the form of single and multi-qubit gates. This hybrid method tends to reduce the resource cost in terms of the number of quantum gates. To simulate the dynamics, the Trotterization method is applied given by

$${e}^{- iHτ} ≃ {( {\prod }_{j = 1}^{} {}^{K} {e}^{- {iH}_{j} τ / n} )}^{n} + O ( {K}^{2} {τ}^{2} / n ) ,$$

where K is the number of Hamiltonian terms, n is the number of trotter steps, and τ is the evolution time.

Fermion-boson interactions encompass the interactions that arise between fermions, i.e. particles characterized by half-integer spins, as exemplified by electrons- and bosons-particles with integer spins. These interactions manifest in diverse physical domains, including the realms of particle physics and condensed matter physics. A prominent illustration lies in the interplay between electrons (fermions) and photons (bosons), constituting the foundational force behind electromagnetic interactions that underpin our observable universe. Additionally, within the context of the strong nuclear force, fermions such as quarks interact through the exchange of gluons (bosons), facilitating the powerful binding of protons and neutrons within atomic nuclei. This intricate interplay of fermion-boson interactions not only shapes the fundamental forces governing our universe but also serves as a cornerstone in comprehending the dynamic nature of matter and energy.

Electron-phonon (e-ph) and fermion-boson interaction models (systems) are essential tools for understanding and manipulating charge and energy flow in various electronic, photonic, and energy conversion devices. These models are important to study conventional superconductivity and charge modulation. For ideal 1-D systems, any electron-phonon coupling leads to a charge density wave. Electron-phonon interactions play an important role in high-temperature superconductivity through the formation of polarons or bipolarons.

Strong e-ph interactions and electron-phonon coupling can both lead to substantial correlation effects and localization in metallic systems in condensed matter. Strong e-ph interactions have been found in a number of significant materials, including cuprates, fullerides, and manganites. The interplay of electron-electron (e-e) and e-ph interactions in these correlated systems leads to the coexistence or competition between various phases such as superconducting, charge-density-wave or spin-density-wave phases, or formation of novel non-Fermi liquid phases, polarons, bipolarons, etc. Moreover, it can be a dominant factor in determining the transport properties of biomolecules.

In certain embodiments, the superconducting circuit comprises qubits, resonators and/or SQUIDs as circuit elements, in particular wherein the qubits are transmon qubits, in particular coupled via the resonators and SQUIDs in an array for implementing a tunable interaction between spins and bosons as well as tunable exchange interactions between spins. This may be realized in the same setup by the tunable interaction between the transmon qubits.

A magnetic flux may be supplied to the SQUIDs to control the interactions in the superconducting circuit. A SQUID operates based on two Josephson junctions embedded in a superconducting loop. Josephson junctions allow a Cooper pair that are electron pairs exhibiting superconductivity to tunnel through a non-superconducting barrier. The key to controlling a SQUID is through the manipulation of magnetic flux within its loop. This flux influences the phase difference across the junctions, directly affecting the supercurrent (the current that flows without electrical resistance) that the SQUID can carry.

Transmon qubits superconducting qubits used in quantum computing, characterized by their enhanced coherence times and reduced sensitivity to charge noise, which is achieved through a Josephson junction shunted by a large capacitance.

Quantum state tomography is a technique used in quantum computing to determine the state of a quantum system. Essentially, it involves reconstructing the unknown quantum state based on measurements taken from the system. By performing a complete set of measurements and applying statistical analysis, the density matrix of the quantum state—a mathematical representation that encapsulates all the probabilities of the outcomes of possible measurements—can be inferred. This process is crucial for verifying quantum operations, such as those performed by qubits in a quantum computer, as it allows researchers to understand and validate the results of quantum algorithms, error correction procedures, and other operations essential to quantum information processing.

The Hubbard-Holstein model describes a system of interacting electrons that also couple to a set of harmonic oscillators representing phonons. The model includes the on-site Coulomb repulsion between electrons, which tends to localize the electrons and prevent them from occupying the same site, and the electron-phonon interaction, which causes the phonons to modulate the local energy landscape of the electrons and can lead to a net attraction between them.

Despite its simplicity, the Hubbard-Holstein model is a highly nontrivial problem and cannot be solved exactly in one dimension, or even in higher dimensions, except for some special cases. The difficulty arises from the fact that the interaction between the electrons and phonons is highly nonlinear, and the Coulomb interaction between the electrons leads to strong correlations and many-body effects.

The Jordan-Wigner transformation is a method used in quantum mechanics to map fermionic operators to spin operators, facilitating the computation or simulation of fermionic systems on quantum computers. It converts fermionic annihilation and creation operators, which obey anticommutation relations, into tensor products of Pauli matrices that operate on spin-1/2 systems (like qubits).

Quantum Simulations: Simulation of such correlated systems is a daunting task given that their Hilbert space grows exponentially with the size of the system. Quantum simulation aims to address this problem by encoding the system into the subspace of a controllable quantum system.

Quantum simulators are controllable quantum systems that may be used to mimic other quantum systems of relevance and have garnered renewed and growing attention. The employment of efficient quantum simulators with low error rates would be highly beneficial for a range of physics, chemistry, and biology issues. They have demonstrated their ability to solve challenging quantum many-body issues in condensed-matter physics, such as those involving correlated electrons or quantum magnetism. In order to predict or study states of matter that are challenging to reach experimentally, quantum simulators are useful in certain embodiments of the invention.

Quantum simulators are basically of three types: digital, analog, and digital-analog. The digital quantum simulation is limited by high error rates while the analog quantum simulation does not offer much flexibility since it is applicable to specific types of systems. On the other hand, digital-analog quantum simulation merges the two approaches to realize low error and high-performance computations.

Digital quantum computing (DQC) is based on the application of sequences of single-qubit and multi-qubit gates. These operations are termed “digital blocks” and the protocol is known as a digital quantum algorithm. DQC is limited by the fact that it is resource-consuming and does not display robustness to errors in the computation. This makes DQC challenging to implement important and complex problems and reach quantum advantage.

Analog quantum computing (AQC) involves simulators that can emulate the desired physical system as closely as possible by mimicking its dynamic and statistical properties. The aim is to design a simulator whose Hamiltonian can be engineered to match the properties of the target system. Such systems offer low errors and scalability. The tradeoff is that such simulators are only limited to specific quantum systems and do not offer much flexibility.

Digital-analog quantum computing (DAQC) aims to combine the digital and analog methods in terms of digital pulses and natural interactions provided by the system to produce efficient simulations with low error and high flexibility. DAQC exhibits superior scalability than solely digital approaches in the same NISQ devices by combining digital methods, which offer flexibility, with analog approaches, which are robust against errors. In line with the noisy intermediate scale quantum era (NISQ), this hybrid approach seeks to minimize the number of quantum gates required for computation.

DAQC takes advantage of the inherent interactions offered by the platform system's Hamiltonian along with single-qubit rotations to perform efficient computation. The native interactions provide the analog part of the simulation while the single and multi-qubit gates provide the digital part. The task is to find a mapping between these digital and analog blocks and the target Hamiltonian to be simulated. Different platforms provide different sets of analog and digital blocks and hence a suitable mapping needs to be implemented. In the method of the invention, different terms such as individual qubit or resonator and qubit-resonator interactions, offered by the digital-analog simulator can be turned on or off to reach the target Hamiltonian.

DAQC has been used to propose the realistic implementation of the quantum Fourier transform, the quantum approximate optimization algorithm (QAOA), in the simulation of fermionic models and for the simulation of quantum chemistry and transport phenomena in biomolecules. This hybrid method is expected to perform better than digital quantum computing in terms of producing low error and high performance.

The electron-phonon systems include models such as the Hubbard-Holstein model that involves both the electron-phonon couplings and the coulomb interactions between the electrons, the Holstein model that excludes Coulomb repulsion between the electrons and the phenomena of charge transport in biomolecules.

The target Hamiltonian (also referred to here as problem Hamiltonian) is the Hamiltonian that needs to be mapped using the superconducting architecture proposed and simulated by applying the DAQC method.

The circuit Hamiltonian is the Hamiltonian of the superconducting circuit architecture obtained after circuit quantization.

An expectation value is a mean value obtained after several repetitions of single experimental measurements of a physical quantity in a quantum experiment.

A quantum gate is a fixed unitary evolution. An example is a multi-qubit operation,

$${U}_{N} = {e}^{i π / 4} {σ}_{1}^{z} {σ}_{2}^{z} .$$

A digital block (or gate) is a fixed unitary evolution up to a set of local rotations up to 2-qubits.

The examples are parameter-fixed entangling quantum gates and single qubit rotations with arbitrary angles as

$${U}_{N} ( ϕ ) = ( {e}^{i {ϕ}_{1}} {σ}_{1}^{z} ⊗ {e}^{i {ϕ}_{2}} {σ}_{2}^{z} ) {e}^{i π / 4} {σ}_{1}^{z} {σ}_{2}^{z} ,$$

$$and$$

$${U}_{i} ( ϕ ) = {e}^{i ϕ} {σ}_{1}^{z} .$$

$${U}_{MS}^{2} ( θ , 0 ) = {e}^{- i θ / 4} {σ}_{1}^{x} {σ}_{2}^{x} .$$

An analog block (or gate) is a parameterized entangling unitary evolution with more than one parameter. An example is a parameter-dependent multi-qubit operation

$${U}_{A} ( ϕ ) = {e}^{i ϕ} {σ}_{1}^{z} {σ}_{2}^{z} .$$

Another example is a two-parameter-dependent multiqubit operation in trapped ions (global MS gate) as

$${U}_{MS}^{n} ( θ , ϕ ) = {e}^{- i \frac{θ}{4} {( cos ϕ {S}_{x} + sin ϕ {S}_{y} )}^{2}}$$

$$wherein$$

$${S}_{x ( y )} = {\sum }_{i} {σ}_{i}^{x ( y )}$$

Native nearest neighbor or all-to-all interactions can serve as an analog block as in the case of Ising Hamiltonian. In the case of hybrid fermion-boson systems, the native boson terms and fermi-boson interaction terms can be employed as analog blocks.

In certain embodiments, the native spin-boson interaction of the superconducting circuit is used as analog blocks. This means that the fundamental quantum mechanical interactions inherent to the system are leveraged directly for computational or simulation tasks. This approach harnesses the intrinsic properties of superconducting circuits, where the spins (typically represented by superconducting qubits) interact with bosonic modes (such as, for example, photons in microwave cavities or phonons in mechanical resonators).

In certain embodiments, the interaction between the qubits and the resonators is used for the analog blocks, and is adapted to be equal to the spin-boson interaction in the target Hamiltonian up to single qubit rotations. This means that the system's architecture is configured to replicate specific quantum interactions. This setup allows for a precise emulation of the physical system under study, captured by the target Hamiltonian, by using the quantum circuit itself and just by using single qubit rotations applied using external magnetic fluxes the device Hamiltonian can be changed to mimic the target Hamiltonian.

In certain embodiments, the interactions between the qubits are tuned using external magnetic fluxes which constitute the digital blocks in the form of single and/or multi-qubit gates. This means that the functioning of the quantum gates (the basic operations of quantum computation), which can involve single or multiple qubits, is controlled by adjusting external magnetic fields. These adjustments effectively manipulate the quantum states and interactions of the qubits, allowing for the execution of quantum computational tasks and the dynamic configuration of quantum circuits.

In certain embodiments, the interactions are mentioned above are
exchange and/or Coulomb interactions comprising the digital blocks and/or
bosonic and fermi-bosonic interactions comprising the analog blocks.

Exchange interactions involve the quantum mechanical property where two fermions, such as electrons, virtually swap positions, affecting their quantum states without physical movement, crucial for entangling qubits and performing logic operations. Coulomb interactions, based on the electrostatic forces between charged particles, also manipulate qubit states to execute quantum gates.

Bosonic and fermi-bosonic interactions comprising the analog blocks are defined by the ways in which bosons and fermions interact within a quantum computing framework. In analog blocks, these interactions typically include phenomena like the coupling of phonons in optical cavities or phonons in lattice structures, Superconducting quantum circuits use Josephson junctions to realize qubits and their parallel connections to realize superconducting quantum interference devices (SQUIDs). Quantum computation with superconducting circuits exploits the intrinsic coherence of the superconducting state, into which all electrons are condensed. The number of superconducting electrons stores the quantum information. These systems are fabricated with thin film technology and operated at temperatures below 100 mK. Measurements are performed with integrated on-chip instruments. The access to macroscopic parameters allows tuning the system properties such as frequency and coupling strength and offers better scalability than other quantum platforms.

Quantization of superconducting circuits involves calculating the Lagrangian of the system, then using Hamilton's equation of motions to derive the classical Hamiltonian which is quantized by promoting the variables to operators satisfying canonical commutation relations.

The computer-implemented method for simulating a system, in particular for simulating a fermion-boson interacting system, comprises the design of a suitable superconducting circuit architecture mapped to the target system. The target system can be, for example, an electron-phonon system whose Hamiltonian is described as

$$H = - t {\sum }_{i , σ} ( {c}_{i , σ}^{†} {c}_{i + 1 , σ} + {c}_{i + 1 , σ}^{†} {c}_{i , σ} ) + U {\sum }_{i} {n}_{i ↑} {n}_{i ↓} + g {\sum }_{i , σ} {n}_{i σ} ( {a}_{i} + {a}_{i}^{†} ) + {ℏω}_{0} {\sum }_{i} {a}_{i}^{†} {a}_{i} ,$$

where t is the tunneling amplitude between sites, U is the Coulomb repulsion, ω₀ is the frequency of the phonon modes, g is the coupling strength between electrons and phonons,

$${c}_{i σ}^{†} ( {c}_{i σ} )$$

creates (annihilates) an electron with spin σ∈{↑,↓} at the site i,

$${a}_{i}^{†} ( {a}_{i} )$$

is the phononic creation (annihilation) operator, and

$${n}_{i σ} = {c}_{i σ}^{†} {c}_{i σ}$$

the electronic number operator.

The superconducting architecture considered to simulate this target Hamiltonian consists of a linear chain of qubits coupled with resonators and superconducting quantum interference devices (SQUIDs) that emulate a system of a 1D linear system of electronic spins coupled via phonons. The quantum Hamiltonian of the superconducting architecture is obtained via circuit quantization and then mapped with this target Hamiltonian. The various digital and analog blocks offered by the superconducting architecture are identified based on what interactions that are engineered using digital pulses and what are the natural interactions available. The combination of these blocks constructs a digital-analog protocol for the simulation. Each SQUID is used for coupling a pair of qubits and a resonator so that the coupling parameters of these qubit-resonator interactions can be changed using external fluxes supplied through the SQUIDs.

After decomposing the problem Hamiltonian into digital and analog blocks, it is time evolved using the Trotter-Suzuki formula. Quantum Fidelity is calculated to benchmark the simulation results.

In particular, digital-analog quantum computing is performed using superconducting circuits in the context of the invention.

Hardware for the computation procedure: The hardware architecture described herein in relation to the invention is adapted for the computation and simulation of fermion-boson systems as illustrated in FIG. 1. FIG. 2 delineates the structural design of this architecture, which fundamentally comprises transmon qubits, resonators, and superconducting quantum interference devices (SQUIDs). This system is initially demonstrated for two sites, each site consisting of one fermion and one boson. However, the design is inherently scalable and can be extended to ‘n’ sites by integrating additional qubits and resonators.

Transmon Qubits: The transmon qubits are central to our architecture, functioning as the fermionic components. These qubits are a type of superconducting charge qubit characterized by their enhanced robustness against charge noise, which is crucial for maintaining coherence in quantum computations. Each qubit at a site represents a fermion, such as an electron in a physical system.

Resonators: Each resonator in the architecture acts as a bosonic element. These are typically microwave photonic or phononic resonators depending on the desired simulation. The resonators are configured to couple with transmon qubits, thereby facilitating the emulation of bosonic behaviors and interactions within the fermion-boson system. In our setup, each resonator is paired with a transmon qubit at each site to simulate the dynamics between fermions and bosons.

SQUIDs: A SQUID is a sensitive magnetometer used to measure extremely weak magnetic fields, based on superconducting loops containing Josephson junctions. The SQUIDs are employed in the invention to control the interactions between the qubits and resonators. These devices function by altering the magnetic flux through the loop of the SQUID, which in turn modifies the effective Josephson junction energy, thereby adjusting the qubit-resonator coupling. This capability allows for precise modulation of the interaction strength and characteristics between the fermionic and bosonic components, crucial for accurately obtaining the system's desired Hamiltonian.

Scalability and Interaction Control: The architecture allows for scalability from the basic two-site setup to multiple sites by systematically coupling additional qubits and resonators. This scalability is vital for simulating larger and more complex fermion-boson systems. Each additional site integrated into the system is similarly equipped with a transmon qubit and a resonator, linked via SQUIDs to enable controlled interaction adjustments across the expanded architecture. By manipulating the magnetic flux through these SQUIDs, we can tailor the Hamiltonian of the entire system to replicate various quantum mechanical scenarios.

This unique configuration and the method of coupling and control provide a versatile and powerful tool for the simulation of complex quantum systems, offering significant advancements in the field of quantum computing and simulation.

Computation procedure: For the computation of the fermion-bosons systems shown in FIG. 1, the inventors provide the design of the architecture which is shown in FIG. 2. The design comprises or consists of transmon qubits connected using resonators and SQUIDs which is shown for two sites, meaning for two fermions and two bosons where each site consists of one fermion and boson each. This can be extended up to n sites by coupling more qubits with resonators. The qubits function as the fermions while the resonators function as the bosons. Magnetic fluxes are applied to the SQUID in order to control the interactions between the different parts of the system. By controlling these interactions one can obtain the desired Hamiltonian of the system to be simulated.

Simulation procedure: In some embodiments, the hybrid digital-analog method to perform quantum simulation of electron-phonon interactions comprises or consists of tunnelling (exchange) interactions, the Coulomb repulsion, and the individual electron and phonon terms. Examples of such systems are the generalized Hubbard-Holstein model incorporating both the electron-phonon couplings and the coulomb interactions between the electrons, the Hubbard model that excludes electron-phonon couplings, the Holstein model that excludes Coulomb repulsion between electrons and the Bose-Hubbard model that involves interacting spinless bosons on a lattice.

In some embodiments, when applied for digital-analog quantum computing, the method uses a target Hamiltonian that needs to be encoded into a superconducting circuit architecture consisting of qubits coupled by resonators and SQUIDs. In some embodiments, digital-analog quantum computing is performed in the method using superconducting circuits, in particular with qubits coupled with resonators and SQUIDs in a 1D linear chain architecture.

In some embodiments of the method, for digital-analog quantum computing, a 1D linear chain mapping of electron-phonon interactions is performed using Jordan-Wigner transformation and a corresponding 1D linear chain architecture is designed or adapted using superconducting circuits for quantum simulation.

In some embodiments of the method for superconducting circuits, it comprises providing an architecture according to the 1D linear chain electron-phonon interactions and based on the mapped target Hamiltonian suitable for encoding electron-phonon interacting systems and simulated using digital-analog quantum algorithm.

The superconducting architecture is mapped to the target Hamiltonian and simulated using digital-analog methods.

In certain embodiments of the method, the Hamiltonian of the superconducting architecture is decomposed into digital and analog blocks by separating the natural interactions with the interactions that need to be transformed to reach the target Hamiltonian, in particular followed by a Trotterization of each block.

In certain embodiments of the method of the invention, the computation involves decomposing the mapped Hamiltonian into different digital blocks, consisting of terms that need to be supplied with digital pulses and the analog blocks consisting of the natural interactions provided by the architecture. After this decomposition, the Trotter-Suzuki method is applied for the simulation.

The Trotterization of the superconducting circuit Hamiltonian may be performed to simulate the target Hamiltonian.

In certain embodiments of the method of the invention, the dynamics of polaron and bipolar formations are studied using the superconducting architecture for simulating electron-phonon interactions.

In certain embodiments of the method of the invention, any of the preceding claims, implemented on analog hardware using digital pulses superimposed on the native analog block of the hardware.

In certain embodiments of the method of the invention, the quantum fidelity of the simulation is considered for benchmarking the simulation results of the digital-analog method with respect to purely digital or analog methods.

In another aspect, the invention refers to the application of the method described herein in quantum chemistry and materials.

In another aspect, the invention refers to a system for performing a method described herein, comprising
a superconducting quantum architecture, and
digital-analog quantum simulation protocol to efficiently simulate the target Hamiltonian with high fidelity.

In another aspect, the invention refers to a computer program having a program code for performing the method as described herein, when the computer program is executed on a computer, a processor, a quantum processor, and/or a programmable hardware component.

In another aspect, the invention refers to a computation device comprising: an interface for communicating with a quantum-processing unit; and one or more processors configured to perform the method described herein using the quantum processor.

In another aspect, the invention refers to the use of superconducting qubits and resonators for quantum computation with superconducting circuits.

In another embodiment, the invention refers to a method, in particular a computer-implemented method, for simulating electron-phonon interacting systems, comprising the step of
providing a superconducting circuit architecture with tunable coupling for encoding electron-phonon interacting systems.

Tunable parameters of the proposed device may be the qubit-resonator coupling and parameters of the qubits and resonators.

In certain embodiments, the invention refers to a method for solving a considered problem, comprising the step of:
Using an arbitrary number of qubit-resonator coupling in superconducting circuits platform with tunable coupling for encoding a considered problem, in particular wherein a target Hamiltonian is given corresponding to the system to be simulated.
An arbitrary number of qubit-resonator coupling refers to any integer value. The minimum number of qubits is 2, and the minimum number of resonators and SQUID is 1.

In another aspect, the invention refers to the use of the method described herein in quantum chemistry and materials.

In certain embodiments of the method of the invention, the property of the material that is being determined is selected from the group consisting of transport properties, correlation effects, polaron formation, bipolaron formation and localization phenomena.

Transport properties encompass these phenomena and describe how materials conduct electricity, heat, or other forms of energy and how electrons or phonons propagate through the material, which is vital in semiconductor technology. Correlation effects are interactions between electrons that cannot be described by treating the electrons as independent, often leading to complex behaviors like magnetism and superconductivity. Correlation Effects arise from interactions between electrons that can lead to unconventional conductive states or insulating behavior, critical in novel electronic materials. Polaron Formation refers to the process where an electron moving through a material distorts the surrounding lattice, forming a composite particle that includes both the electron and the lattice distortion. Polaron formation is, for example, the process by which an electron in a crystal lattice distorts the surrounding lattice, affecting the electron's mass and mobility; affecting, for instance, the efficiency of solar cells. Bipolaron Formation occurs when two polarons (each a combination of an electron and lattice distortion) attracts and bind together, forming a coupled state. Bipolaron formation is a related phenomenon where two polarons bind together, which can play a significant role in high-temperature superconductivity. Localization phenomena refer to the tendency of particles, particularly electrons, to become spatially localized or trapped in a fixed position due to disorder in the material, often resulting in the material acting as an insulator and are a key consideration in understanding and designing disordered materials and devices.

The properties of a material such as conductivity, magnetoresistance, superconductivity, and others are critical for understanding its behavior and potential applications.

Conductivity refers to the material's ability to conduct electric current, which is fundamental in electronic devices. Magnetoresistance is the change in electrical resistance in response to an applied magnetic field, which is key in the operation of hard drives and sensors. Superconductivity is the phenomenon where a material exhibits zero electrical resistance and expulsion of magnetic fields, enabling highly efficient power transmission and magnetic levitation.

Each of these properties is critical for material scientists and engineers in tailoring materials for specific applications in technology and research.

For example, the property of interest of the material may be polaron formation. A possible objective of such applying the method of the invention would be to determine the dynamics and characteristics of polaron formation in a material using a quantum simulation or quantum computation on a superconducting circuit system. For this purpose, a material known or suspected to exhibit significant electron-phonon interactions is chosen, such as a high-temperature superconductor or a transition metal oxide.

In this example, the computation or simulation process could comprise the provision of the target Hamiltonian, the mapping of the Hamiltonian, the configuration of the superconducting circuit, the execution of the quantum calculation, as well as data collection and analysis and interpretation. The steps described here apply to the invention with respect to other properties in an analogous fashion.

### 1. Hamiltonian Definition:

Target Hamiltonian: Defining and/or providing a Hamiltonian that encodes the electron-phonon interactions responsible for polaron formation. (For other properties, the Hamiltonian is adapted accordingly.) This typically involves terms that describe electron mobility (tunneling terms), electron-electron interactions (Coulomb repulsion), and coupling between electrons and lattice vibrations (phonons). The Holstein model may be used, for example, where an electron interacts with local phonons, leading to self-trapping under strong coupling conditions. Other models may also be used.

### 2. Mapping the Hamiltonian:

Using the Jordan-Wigner transformation to map the fermionic part in a purely fermionic, or hybrid fermionic-bosonic system described by the Hamiltonian into a spin or hybrid spin-bosonic system. Each spin in the 1D chain represents an electron, and each is coupled to a quantum resonator representing phononic degrees of freedom. (The Jordan-Wigner transformation is performed for the fermionic part only.)

### 3. Superconducting Circuit Configuration:

Circuit Elements: Implementing the mapped spin, bosonic system using a superconducting circuit with elements such as qubits (e.g., transmon qubits), resonators, and/or SQUIDs.
Interaction Tuning: Using magnetic flux through SQUIDs to control the strength and nature of interactions between spins (electrons) and bosons (phonons), simulating the real electron-phonon coupling in the material.

### 4. Quantum Simulation Execution:

Analog Blocks: Using the native spin-boson interactions provided by the circuit to simulate the continuous interactions between electrons and phonons that lead to polaron formation.
Digital Blocks: Implementing tunable exchange interactions and multi-qubit gates to simulate additional quantum dynamics, such as corrections from higher-order interactions or environmental effects.

### 5. Data Collection and Analysis:

Performing a Calculation or Simulation: Execute the calculation/simulation while systematically varying parameters like coupling strength or phonon frequency to observe how these changes affect polaron formation.
Outcome States: Measure the outcome states of the superconducting circuit, focusing on signs of polaron formation, such as localized electron states with accompanying lattice distortions.

### 6. Interpretation:

Comparison with Theory and Experiments: Optionally, compare the simulation results with theoretical predictions and experimental data to validate the model and the effectiveness of the quantum simulation in capturing the complexities of polaron formation.

In another aspect, the invention refers to a computer program having a program code for performing the method described herein, when the computer program is executed on a computer, a processor, a quantum-processing unit, and/or a programmable hardware component.

In another aspect, the invention refers to a computation device comprising: an interface for communicating with a quantum-processing unit; and one or more processors configured to perform the aforementioned method using the quantum-processing unit.

In another aspect, the invention relates to a data processing apparatus/device/system comprising means for carrying out the method of the invention as described herein.

In particular, the invention relates to a method for performing quantum simulation of electron-phonon systems described herein, comprising
a quantum simulator with tunable coupling,
a memory to save the results of the measurements of states and expectation values of a final Hamiltonian.

In another embodiment, the invention refers to a method, in particular a computer-implemented method, for simulating fermion-boson interacting systems using a digital-analog quantum algorithm in superconducting circuits.

In another aspect, the invention refers to a system comprising
a superconducting circuit device with tunable coupling and free energies,
a digital-analog quantum computing method to efficiently simulate the target Hamiltonian.

In another aspect, the invention refers to the use of the method described herein in quantum chemistry and materials.

In another aspect, the invention refers to a computer program having a program code for performing the method of one of the before mentioned claims, when the computer program is executed on a computer, a processor, a quantum-processing unit and/or a programmable hardware component.

In another aspect, the invention refers to a computation device comprising: an interface for communicating with a quantum-processing unit; and one or more processors configured to perform the aforementioned method using the quantum-processing unit.

In another aspect, the invention relates to a computer program (product) comprising instructions which, when the program is executed by a computer, cause the computer to carry out the method of the invention as described herein.

In another aspect, the invention relates to a computer-readable data carrier having stored thereon said computer program (product).

In another aspect, the invention relates to the use of a superconducting state for quantum computation with superconducting circuits.

### FIGURES

The figures show:

FIG. 1: 2-site Hubbard-Holstein model in spin representation with each site decomposed into two opposite spins interacting with phonon modes (represented by harmonic potentials). Intersite interactions are mediated via tunneling terms while intrasite interactions are mediated via Coulomb (U) and spin-phonon terms. U=Coulomb potential, t=Tunnelin rate, g=spin-phonon coupling, ω=phonon mode frequency.

FIG. 2: 1D superconducting circuit architecture for 2-site Hubbard-Holstein model consisting of qubits coupled via resonators and superconducting quantum interference devices to emulate the spin representation of the 2-site Hubbard-Holstein model. The device consists of qubits (Qⱼ) coupled with resonators (Rⱼ) using SQUIDs (double-crossed junctions) in a linear array. Rᵢ=Resonators, Qᵢ=Qubits.

FIG. 3: The schematic diagram of a digital-analog quantum computing protocol consisting of separate digital steps and analog blocks. The analog blocks are represented in grey. U=consists of electron-phonon coupling terms in Eq. 10-11. Uᵢₙᵢₜᵢₐₗ=initial state, H=Hadamard gate, U* and U_{XY}=analog blocks, U_{XX} and U_{YY}=Digital blocks.

FIG. 4: (a) Fidelity, [symbol] ψ_{exact}|ψ_{DAQS} [symbol] vs time between the exact simulation and digital-analog quantum simulation (DAQS). The initial state is |ψ_{qubit} [symbol] =|= [symbol] , |ψᵣₑₛ [symbol] =|0 [symbol] and the coupling parameters are t=0.5, U=1, g=0.5 and ω₀=4 (all in GHz).

(b): Fidelity, [symbol] ψ_{exact}|ψ_{DAQS} [symbol] as a function of time for 20 trotter steps with the system parameters, t=1, U=2 t, g=1 t and ω₀=8 t. The initial state is half-filling, where each resonator is truncated to eight levels.

FIG. 5: CNOTs are used in certain embodiments to perform each bosonic gate vs. the number of levels (n) for each bosonic mode, in particular for a pure digital approach.

FIG. 6: Selected parameters for the system or device Hamiltonian (Eq. 5) to reach the target Hamiltonian of a 1-D, 2-site Hubbard-Holstein model (Eq. 4) described in FIG. 1

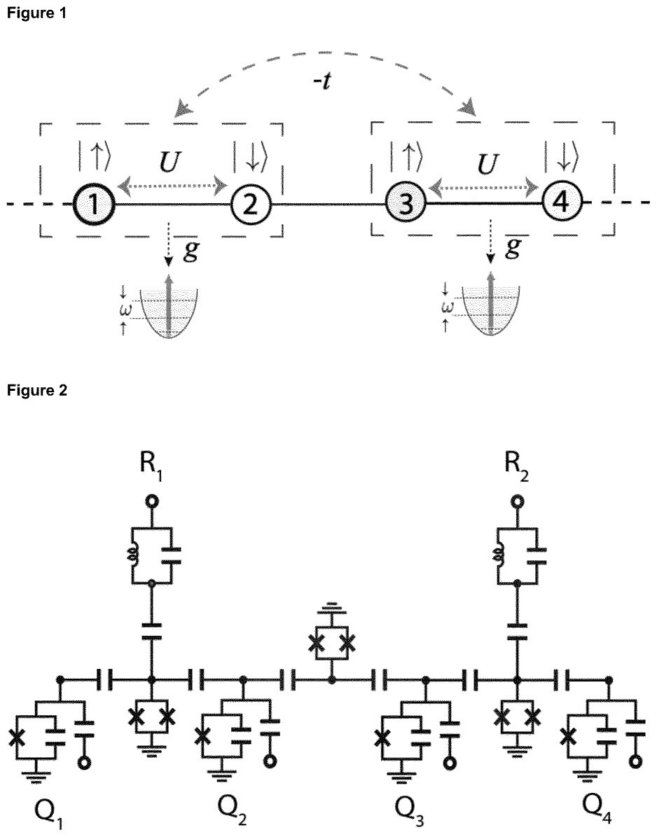

FIGS. 1 to 3 illustrate aspects of the invention, in particular the conceptualization, emulation, and computational implementation of a quantum model based on a 2-site Hubbard-Holstein system, showcasing how theoretical models may be translated into practical quantum computing systems and protocols.

In FIG. 1, the model is visualized using a 2-site Hubbard-Holstein model in a spin representation, where each lattice site is depicted as having two opposite spins. These spins interact not only with each other within the same site via Coulomb interactions and spin-phonon couplings but also with spins on neighboring sites through electron tunneling. Phonon modes, represented by harmonic potentials, play a crucial role in mediating these interactions, introducing dynamics influenced by the quantum mechanical properties of vibrations within the lattice. This model captures the essential physics of strongly correlated electronic systems and their interaction with lattice vibrations, which are pivotal for studying phenomena such as superconductivity and magnetism.

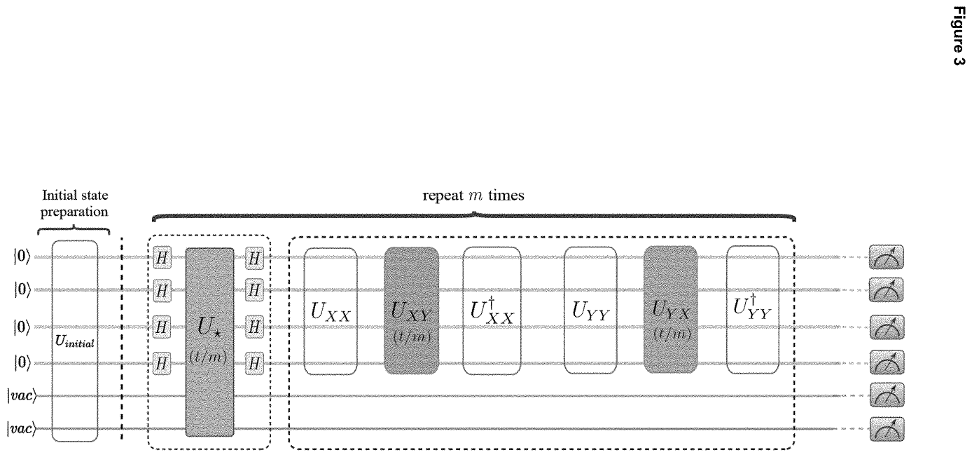

Expanding from the theoretical model, FIG. 2 shows how the Hubbard-Holstein model is emulated in certain embodiments of the invention using a one-dimensional superconducting circuit architecture. In this setup, quantum bits (qubits), symbolized as Qj (Q₁, Q₂, Q₃, and Q₄), are coupled via resonators (Rj) (R₁ and R₂), where the numbers indicate the qubit and resonator indexes. Their interactions are finely controlled by Superconducting Quantum Interference Devices (SQUIDs). The SQUIDs function as tunable coupling elements (represented by double-crossed junctions), allowing precise control over the interaction strength and phase between qubits. This architecture mimics the spin-spin interactions and phonon dynamics of the original quantum model, enabling the exploration of quantum behaviors and properties in a controlled laboratory setting.

FIG. 3 describes a hybrid digital-analog quantum computing protocol that is designed or adapted to leverage the strengths of both discrete digital operations and continuous analog processes. The digital steps involve discrete manipulations of qubit states, ideal for implementing precise quantum gates and algorithms. In contrast, the analog blocks, highlighted in grey, involve continuous operations that emulate the natural dynamics of the system, such as the electron-phonon interactions described in Equations 10 and 11. This hybrid approach allows for more efficient simulations and computations, particularly for models like the Hubbard-Holstein model that involve complex interactions and dynamics.

### EXAMPLES

2-site 1D Hubbard-Holstein Model

The Hubbard-Holstein (HH) model is a generalized model of electron-phonon systems incorporating both the electron-phonon couplings and the coulomb interactions between the electrons. This model is a hybrid between the Hubbard model which excludes electron-phonon couplings (g=0) and the Holstein model which excludes Coulomb repulsion between electrons (U=0). Electron-phonon interaction is essential to manipulating charge and energy flow in various electronic, photonic, and energy conversion devices. These models are important tools regarding conventional superconductivity and charge modulation. For ideal 1-D systems, any electron-phonon coupling leads to a charge density wave.

The 1D Hubbard-Holstein model is described by the following Hamiltonian

$$H = - t {\sum }_{i , σ} ( {c}_{i ,}^{†} {c}_{i + 1 , σ} + {c}_{i + 1 , σ}^{†} {c}_{i , σ} ) + U {\sum }_{i} {n}_{i ↑} {n}_{i ↓} + g {\sum }_{i , σ} {n}_{i σ} ( {a}_{i} + {a}_{i}^{†} ) + {ℏω}_{0} {\sum }_{i} {a}_{i}^{†} {a}_{i} , \qquad ( 1 )$$

where the fermionic operator

$${c}_{i σ}^{†} ( {c}_{i σ} )$$

creates (annihilates) an electron with spin

$$σ ∈ \{ ↑ , ↓ \}$$

at the site i,

$${a}_{i}^{†} ( {a}_{i} )$$

is the phononic creation (annihilation) operator, and

$${n}_{i σ} = {c}_{i σ}^{†} {c}_{i σ}$$

the electronic number operator. The first term in the Hamiltonian corresponds to the nearest-neighbor hopping of the electrons. U represents the onsite Coulomb interaction between the electrons. The electron-phonon coupling strength is denoted by g and ℏω₀ corresponds to the energy of each phonon mode. From hereon, ℏ=1 is assumed. For two sites, the Hamiltonian can be written as

$${H}_{2 S} = - t {\sum }_{σ = ↑ , ↓} ( {c}_{1 , σ}^{†} {c}_{2 σ} + {c}_{2 , σ}^{†} {c}_{1 σ} ) + U {\sum }_{i = 1}^{2} ( {n}_{i} {n}_{i} ) + {ω}_{0} {\sum }_{i = 1}^{2} ( {a}_{i}^{†} {a}_{i} ) + g {\sum }_{i = 1}^{2} {n}_{i} ( {a}_{i} + {a}_{i}^{†} ) \qquad ( 2 )$$

### Polarons and Bipolarons in the Hubbard-Holstein Model

Polarons are quasi-particles corresponding to the self-trapping of electrons by the lattice through the strong electron-phonon interaction. In this invention, digital-analog quantum computing is used for the quantum simulation of small polaron formation in the Hubbard-Holstein model using superconducting circuits.

### Mapping to Spin Model

The Hubbard-Holstein model is mapped to the spin model to suppress the spin index in the Hamiltonian H_{2S}. The two-site Hubbard-Holstein model is represented in FIG. 1 using spin representation. In the spin representation, each site is decomposed into two opposite spins, where onsite interactions are mediated via σ^{z}σ^{z} interactions, while the intersite interactions are mediated via σ^{x}σ^{y} interactions. By suppressing the spin index, the Hamiltonian can be written as

$${H}_{2 S} = - t {\sum }_{i = 1}^{2} ( {c}_{i}^{†} {c}_{i + 2} + {c}_{i + 2}^{†} {c}_{i} ) + U ( {n}_{1} {n}_{2} + {n}_{3} {n}_{4} ) + {ω}_{0} {\sum }_{i = 1}^{2} ( {a}_{i}^{†} {a}_{i} ) + g {\sum }_{i = 1 ( 3 )} [ ( {n}_{i} + {n}_{i + 1} ) ( {a}_{i}^{†} + {a}_{i} ) ] . \qquad ( 3 )$$

### Jordan-Wigner Transformation

Subsequently, the Jordan-Wigner transform is performed using the mapping of the fermionic operator

$${c}_{i} \to {\prod }_{j = 1}^{i - 1} {σ}_{j}^{z} {σ}_{i}^{-} ,$$

obtaining

$${c}_{i}^{†} {c}_{i + 2} + {c}_{i + 2}^{†} {c}_{i} = \frac{1}{2} ( {σ}_{i}^{x} {σ}_{i + 1}^{z} {σ}_{i + 2}^{x} + {σ}_{i}^{y} {σ}_{i + 2}^{z} {σ}_{i + 3}^{y} ) .$$

After the transformation, one can write the mapped HH model Hamiltonian as

$${H}_{2 S} = - \frac{t}{2} {\sum }_{j = 2 ( 3 )} ( {U}_{j}^{x} {σ}_{j - 1}^{x} {σ}_{j}^{y} {U}_{j}^{x †} - {U}_{j}^{y} {σ}_{j - 1}^{y} {σ}_{j}^{x} {U}_{j}^{y †} ) + \frac{U}{4} {\sum }_{j} ( {σ}_{j}^{z} {σ}_{j + 1}^{z} + {σ}_{j}^{z} ) + {ω}_{0} {\sum }_{j = 1}^{2} {a}_{j}^{†} {a}_{j} + g {\sum }_{j = 1}^{2} [ ( {a}_{j} + {a}_{j}^{†} ) \frac{( {σ}_{j}^{z} + 1 )}{2} ] , \qquad ( 4 )$$

where

$${U}_{j}^{x ( y )} = exp ( - i \frac{π}{4} {σ}_{j}^{x ( y )} {σ}_{j + 1}^{x ( y )} )$$

are the multibody gates.

This target Hamiltonian was simulated using the superconducting architecture shown in FIG. 2.

### Superconducting Circuit Architecture

H_{2S} is the target Hamiltonian that was simulated using digital-analog quantum computing methods in the superconducting circuits platform. The two-site superconducting architecture to simulate the target Hamiltonian is represented in FIG. 2. Here, each site consists of two qubits (spins) interacting with a resonator (phonon) and coupled via a SQUID. The sites are coupled using another SQUID (black color). The Hamiltonian of this architecture can be obtained in certain embodiments via circuit quantization and rotating wave approximation in the interaction picture as

$$H = {\sum }_{j = 1}^{3} \frac{{g}^{( j )}}{4} ( ( {A}_{2} cos {φ}_{2}^{∼ ( m )} - {A}_{3} cos {φ}_{3}^{∼ ( m )} ) {σ}_{j}^{x} {σ}_{j + 1}^{x} - ( {A}_{2} sin {φ}_{2}^{∼ ( m )} + {A}_{3} sin {φ}_{3}^{∼ ( m )} ) {σ}_{j}^{x} {σ}_{j + 1}^{y} + ( {A}_{2} sin {φ}_{2}^{∼ ( m )} - {A}_{3} sin {φ}_{3}^{∼ ( m )} ) {σ}_{n}^{y} {σ}_{n + 1}^{x} + ( {A}_{2} cos {φ}_{2}^{∼ ( m )} + {A}_{3} cos {φ}_{3}^{∼ ( m )} ) {σ}_{n}^{y} {σ}_{n + 1}^{y} ) + {\sum }_{m = 1}^{2} {k}^{( m )} {a}_{m}^{†} {a}_{m} + \frac{1}{2} {\sum }_{j = 1}^{4} {\sum }_{m = 1}^{2} {l}_{m}^{( j )} \{ - {σ}_{y}^{j} ( {a}_{m}^{†} + {a}_{m} ) ( {A}_{4} cos {φ}_{4}^{∼ ( m )} ) + {σ}_{j}^{x} ( {a}_{m}^{†} + {a}_{m} ) ( {A}_{4} sin {φ}_{4}^{∼ ( m )} ) \} \qquad ( 5 )$$

Herein, Aᵢ are the voltage amplitudes of the supplied external voltage to the device, as the external flux through the SQUIDs is to be composed of a DC signal and a small AC signal,

$${φ}_{ext} = {φ}_{DC} + {φ}_{AC} ( t ) , \qquad ( 6 )$$

where φ_{AC}(t)=Σᵢ₌₁⁷Aᵢ cos(vᵢt+φ^{~}ᵢ). g^{(j)} are the coupling strength between the jthe qubits, k is the frequency of mth resonator and

$${l}_{m}^{( j )}$$

are couplings between jth qubit and mth resonator.

To simulate the target Hamiltonian H using the superconducting architecture, single qubit rotations and multi-body gates are used to engineer the necessary interaction terms.

### 1) Exchange Interactions

The tunnelling terms can be implemented using the following 3-body terms using multi-qubit gates

$${σ}_{j - 1}^{x} {σ}_{j}^{z} {σ}_{j + 1}^{x} = {U}_{j}^{x} {σ}_{j - 1}^{x} {σ}_{j}^{y} {U}_{j}^{x †} \to {R}_{{X}_{j} , {X}_{j + 1}} {R}_{{X}_{j - 1} , {Y}_{j}} {R}_{{X}_{j} {X}_{j + 1}}^{†} , \qquad ( 7 )$$

$${σ}_{j - 1}^{y} {σ}_{j}^{z} {σ}_{j + 1}^{y} = {U}_{j}^{y} {σ}_{j - 1}^{y} {σ}_{j}^{x} {U}_{j}^{y †} \to {R}_{{Y}_{j} , {Y}_{j + 1}} {R}_{{Y}_{j - 1} , {X}_{j}} {R}_{{Y}_{j} , {Y}_{j + 1}}^{†} . \qquad ( 8 )$$

where j denotes the qubit in the 1-D chain and R_{Y(X)}=exp(−iπ/4X).

### 2) Coulomb Interactions

The onsite Coulomb interactions can be realized via the gate

$${σ}_{j}^{z} {σ}_{j + 1}^{z} = {H}_{j + 1} {H}_{j} {σ}_{j}^{x} {σ}_{j + 1}^{x} {H}_{j} {H}_{j + 1} \to {H}_{j + 1} {H}_{j} {R}_{{X}_{j} , {X}_{j + 1}} {H}_{j} {H}_{j + 1} . \qquad ( 9 )$$

where Hⱼ denotes the Hadamard gate on jth qubit.

### 3) Electron-Phonon Interactions

The analog blocks contain all the electron-phonon interaction terms save for a single qubit rotation, the analog block U_{A} implements

$${U}_{A} = exp ( - 1 j [ \frac{g}{2} {\sum }_{j = 1}^{2} ( {σ}_{2 j}^{x} + 1 + {σ}_{2 j + 1}^{x} + 1 ) ( {a}_{j} + {a}_{j + 1}^{†} ) ] τ / ℏ ) . \qquad ( 10 )$$

The desired interaction is implemented by adding just a Hadamard gate acting on each qubit

$$\frac{g}{2} {\sum }_{j = 1}^{2} ( {σ}_{2 j}^{z} + 1 + {σ}_{2 j + 1}^{z} + 1 ) ( {a}_{j} + {a}_{j + 1}^{†} ) \to {\prod }_{j}^{4} {H}_{j} {U}_{A} {\prod }_{j}^{4} {H}_{j} \qquad ( 11 )$$

### Trotterization

To study the dynamics of a quantum state governed by the Hamiltonian H, a Trotterization method may be used, such as in this example. The Hamiltonian is decomposed into a sum of K-terms with at most k-local interactions, i.e. H=Σⱼ₌₁^{K}Hⱼ. Using the Suzuki-Trotter formula, the time evolution operator can be approximated as

$${e}^{- iH τ} ≃ {( {\prod }_{j = 1}^{K} {e}^{- {iH}_{j} τ / n} )}^{n} + O ( {K}^{2} {τ}^{2} / n ) \qquad ( 12 )$$

where K is the number of Hamiltonian terms, n is the number of trotter steps, and τ is the evolution time. The second term is the error in the approximation and can be reduced by increasing the number of trotter steps. Also, in some embodiments, higher order trotter approximation is used to further reduce the Trotter error.

The Trotter blocks can be summarized as follows:

### 1) Exchange Interactions

$${e}^{- {iU}_{2}^{x} {σ}_{1}^{x} {σ}_{2}^{y} {U}_{2}^{x †} τ} \to {R}_{{X}_{2} , {X}_{3}} {R}_{{X}_{1} , {Y}_{2}} {R}_{{X}_{2} , {X}_{3}}^{†} , \qquad ( 13 )$$

$${e}^{- {iU}_{2}^{y} {σ}_{1}^{y} {σ}_{2}^{x} {U}_{2}^{y †} τ} \to {R}_{{Y}_{2} , {Y}_{3}} {R}_{{Y}_{1} , {X}_{2}} {R}_{{Y}_{2} , {Y}_{3}}^{†} , \qquad ( 14 )$$

$${e}^{- {iU}_{3}^{x} {σ}_{2}^{x} {σ}_{3}^{y} {U}_{3}^{x †} τ} \to {R}_{{X}_{3} , {X}_{4}} {R}_{{X}_{2} , {Y}_{3}} {R}_{{X}_{3} , {X}_{4}}^{†} , \qquad ( 15 )$$

$${e}^{- {iU}_{3}^{y} {σ}_{2}^{y} {σ}_{3}^{x} {U}_{3}^{y †} τ} \to {R}_{{Y}_{3} , {Y}_{4}} {R}_{{Y}_{2} , {X}_{3}} {R}_{{Y}_{3} , {Y}_{4}}^{†} , \qquad ( 16 )$$

$$where {U}_{j}^{x ( y )} = exp ( - i \frac{π}{4} {σ}_{j}^{x ( y )} {σ}_{j + 1}^{x ( y )} ) .$$

### 2) Coulomb Interactions

$${e}^{- i {σ}_{1}^{z} {σ}_{2}^{z} τ} \to {R}_{{Z}_{1} , {Z}_{2}} \qquad ( 17 )$$

$${e}^{- i {σ}_{3}^{z} {σ}_{4}^{z} τ} \to {R}_{{Z}_{3} , {Z}_{4}} \qquad ( 18 )$$

$${e}^{- i {σ}_{1}^{z} τ} \to {R}_{{Z}_{1}} , {e}^{- i {σ}_{2}^{z} τ} \to {R}_{{Z}_{2}} , {e}^{- i {σ}_{3}^{z} τ} \to {R}_{{Z}_{3}} , {e}^{- i {σ}_{4}^{z} τ} \to {R}_{{Z}_{4}} \qquad ( 19 )$$

### Analog Blocks

The analog blocks comprise the terms

$${U}_{A} = exp ( - 1 i [ \frac{g}{2} {\sum }_{j} ( {a}_{1 ( 2 )} + {a}_{1 ( 2 )}^{†} ) ( {σ}_{j}^{z} + 1 ) ] τ / ℏ ) \to {H}_{j} {U}_{A} {H}_{j} \qquad ( 20 )$$

where Hⱼ is the Hadamard gate acting on the jth qubit, and the terms R_{X(Y)}_{_{□}}_{,Y(X)}_{_{□}} can also be implemented analogically since they are provided by the hardware architecture.

These digital and analog blocks are summarized in FIG. 3.

For the simulation, the dimensionless Hamiltonian H/k is considered and the timescale in units of 1/k is chosen. For different materials, the range of parameters of the HH model Hamiltonian, such as k and U lie between 0.2-10 eV, g is between 0-100 eV and ω lies in the range 0.01-1 eV, corresponding to which the physical timescale of the system is between fs to ps. Considering the microwave driving with the qubit and resonator frequencies in the range 5-10 GHz, the time for one trotter step for the digital blocks comprising the single and two-qubit gates are 10-500 ns while for the analog blocks comprising the bosonic and qubit-bosonic gates are around 72 ns. The initial states of the system are defined using the ordering of the Hilbert space as |Q₁, Q₂, Q₃, Q₄, res₁, res₂ [symbol] , where Qᵢ and resᵢ denote the qubit and resonator subspaces, respectively.

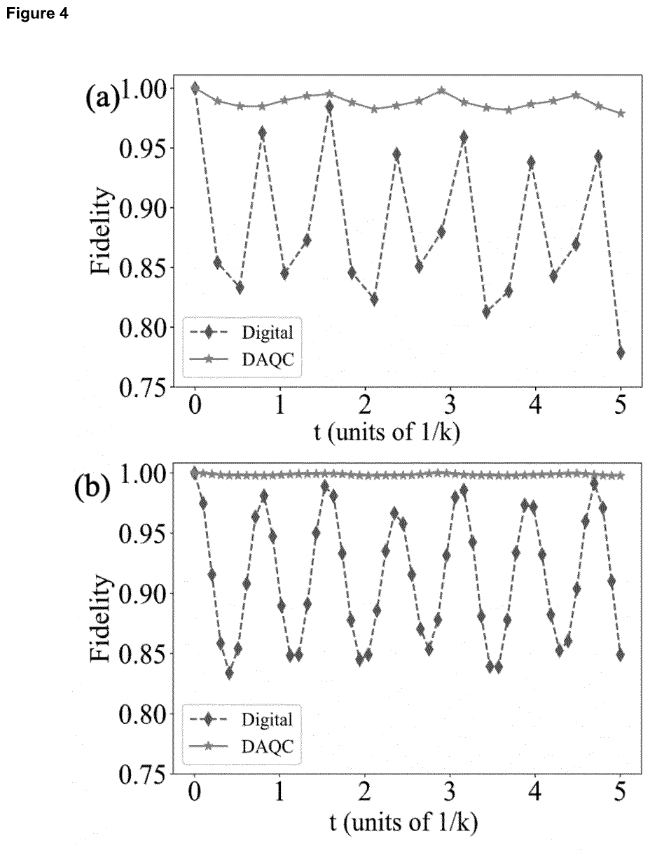

The fidelity and dynamics of the system was investigated by varying the values of g, U, and k. FIG. 4. shows the fidelity of the DAQC and pure digital simulation with respect to the exact simulation with the system initialized at half-filling. Clearly, the DAQC simulation outperforms the pure digital computation, evidently displaying an enhanced performance.

The digital simulation is carried out in certain embodiments using Bosonic Qiskit, where each resonator was truncated to n levels. This requires an order of log₂ n number of digital gates each, apart from the gates required for the qubits. The terms a^{†}a, a^{†}+a, and σ_{z}(a^{†}+a) can be implemented using cv_r( ), cv_d( ), and cvc_d( ) gates, respectively. This is provided by Bosonic Qiskit and corresponds to phase space rotation, displacement, and controlled displacement operators, respectively. When decomposed into digital gates, these bosonic gates can be realized using combinations of single qubit rotations U3(θ,φ,λ) and CNOTs.

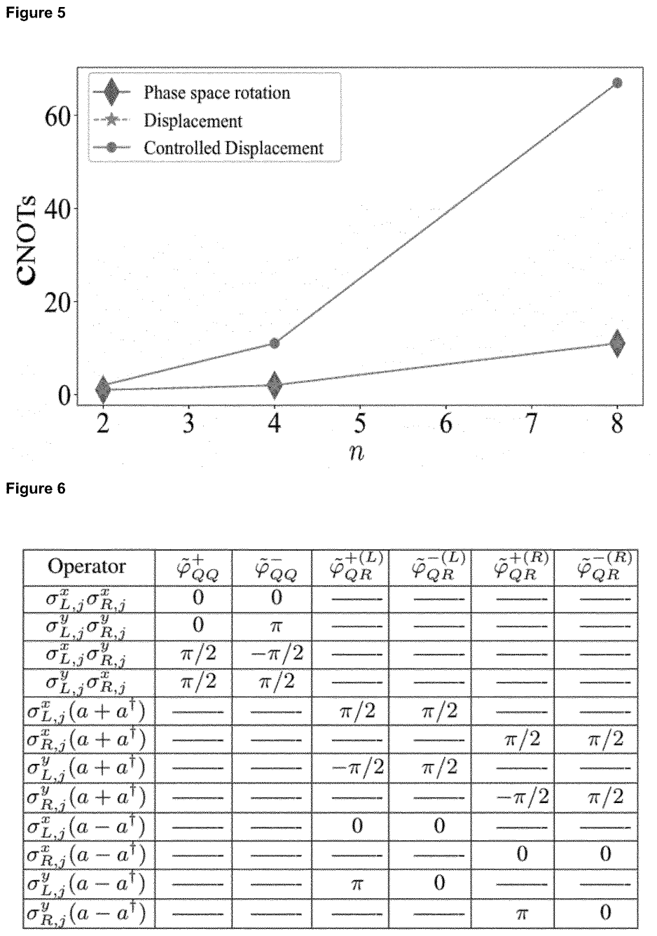

Since entangling gates are common in NISQ processors, the number of CNOTs required for each of these bosonic gates for a single trotter step is estimated. The CNOTs required per bosonic gate with increasing resonator levels (n) are plotted in FIG. 5. The CNOTs required for the gates. cv_r( ) and cv_d( ), grow equally.

1. A computer-implemented hybrid digital-analog method for determining a property of a material, comprising
providing a target Hamiltonian encoding a fermion-boson interaction system representing the property of the material,
mapping the target Hamiltonian into a 1D spin-boson chain, wherein each spin of the 1D spin-boson chain is locally coupled to a resonator of a superconducting circuit, that is provided for implementing a tunable interaction between spins and bosons and tunable exchange interactions between spins and
computing the fermion-boson interaction system within the superconducting circuit, wherein the computation involves simulating the encoded interactions and measuring its effects on the property of the material,
wherein the target Hamiltonian is computed by using native spin-boson interactions of the superconducting circuit and using tunable interactions between spins for constructing digital blocks in the form of at least one of single-qubit gates and multi-qubit gates, and
deriving therefrom the property of the material.

2. The method of claim 1, wherein the target Hamiltonian comprises at least one of tunnelling interactions, Coulomb repulsion, and individual electron and phonon terms.

3. The method of claim 1,
wherein at least one of:
the superconducting circuit comprises at least one of qubits, resonators and SQUIDs as circuit elements, and
a magnetic flux is supplied to the SQUIDs to control the interactions in the superconducting circuit.

4. The method of claim 1, wherein the mapping performed is a linear chain mapping.

5. The method of claim 1, wherein a device Hamiltonian of the superconducting circuit is provided that is decomposed into interactions that are used for the digital blocks and for the analog blocks.

6. The method of claim 1, wherein at least one of:
the native spin-boson interaction of the superconducting circuit is used as analog blocks,
the interaction between the qubits and the resonators is used for the analog blocks, and is adapted to be equal to the spin-boson interaction in the target Hamiltonian up to single qubit rotations, and
the interactions between the qubits are used for the digital blocks in the form of at least one of single-qubit gates and multi-qubit gates.

7. The method of claim 1, wherein the interactions are at least one of:
at least one of exchange and Coulomb interactions comprising the digital blocks, and
bosonic and fermi-bosonic interactions comprising the analog blocks.

8. The method of claim 1, wherein the property of the material is selected from the group consisting of transport properties, correlation effects, polaron formation, bipolaron formation and localization phenomena.

9. The method of claim 1, wherein the property of the material is derived by analyzing the outcome states of the superconducting circuit, wherein said outcome states are processed through quantum state tomography to extract quantitative measures of the material's property.

10. The method of claim 1, wherein the property of the material is selected from the group consisting of conductivity, magnetoresistance, superconductivity, transport properties, correlation effects, polaron formation, bipolaron formation and localization phenomena.

11. The method of claim 1, wherein mapping the target Hamiltonian into a 1D spin-boson chain is performed using a Jordan-Wigner transformation.

12. A non-transitory computer-readable storage medium having stored thereon instructions for implementing the method of claim 1.

13. A computation device comprising: an interface for communicating with a quantum-processing unit; and one or more processors configured to perform the method of claim 1 using the quantum-processing unit.

14. A method for performing computation with superconducting circuits, the method comprises using a superconducting state.

15. A superconducting circuit device for investigating a property of a material,
wherein the superconducting circuit device comprises at least one of qubits, resonators and SQUIDs, wherein a magnetic flux is supplied to the SQUIDs to control the interactions in the circuit.

16. The method of claim 2, wherein the at least one of tunnelling interactions, Coulomb repulsion, and individual electron and phonon terms comprise a Hubbard-Holstein model, a Hubbard model, a Holstein model, or a Bose-Hubbard model.

17. The method of claim 3, wherein the qubits are transmon qubits.

18. The method of claim 4, wherein the linear chain mapping uses a Jordan-Wigner transformation.

19. The method of claim 1, comprising using a superconducting state for quantum computation with superconducting circuits.

20. The superconducting circuit device of claim 15, wherein the property of a material is investigated by performing a quantum simulation of a fermion-boson system.
